(19) United States
(12) Patent Application Publication
(10) Pub. No.: US 2005/0169113 A1
(43) Pub. Date: Aug. 4, 2005

(54) Winding stem structure, and watch having the same

(76) Inventors: Takeshi Tokoro, Chiba-shi (JP); Shigeo Suzuki, Chiba-shi (JP)

Correspondence Address: BRUCE L. ADAMS, ESQ., 50 BROADWAY-31ST FLOOR, NEW YORK, NY, 10004, US

(21) Appl. No.: 11/043,881

(22) Filed: Jan. 26, 2005

(30) Foreign Application Priority Data
Jan. 29, 2004 (JP) 2004-021672

(51) Int. Cl. G04B 19/24

(52) U.S. Cl. 368/319

(57) ABSTRACT

To provide a winding stem structure, which can remove and disassemble two inner and outer winding stem portions, if any, and a watch provided with the winding stem structure. A winding stem structure of a watch comprises a first winding stem including a first gear and a first radially small portion; a second winding stem including a second gear to mesh with the first gear and a second radially small portion, and a joint ring for jointing the first and second winding stems. The joint ring includes a plate-shaped lever member having a first recess opened at its one end for accepting the first radially small portion of the first winding stem removably, and a second recess opened at its one end for accepting the second radially small portion of the second winding stem removably, and a return spring mounted removably and elastically on the plate-shaped lever member while covering the recesses of the first and second recesses of the plate-shaped lever member in the state where the first and second recesses of the plate-shaped lever member accept the first and second winding stems.

### BACKGROUND OF THE INVENTION

1. Field of the Invention

The present invention relates to a winding stem structure for a watch, and a watch provided with the winding stem structure.

2. Description of the Prior Art

The winding stem of the watch is used for the operations to adjust not only the positions of time indicating hands but also a calendar display such as dates and days, and is used for winding the mainspring in the case of a hand-winding mechanical watch.

This winding stem extends at a desired position in a case body so that its outer side end portion may protrude from the side face of the case band or the case body of the watch and so that the portion in the case body may be combined with another watch part to make the aforementioned operations possible. Depending on the internal structure of the watch, that portion of the winding stem, which is positioned in the case body, takes a position displaced from the center portion in the thickness direction of the case body. In the wrist watch or the like, on the other hand, it is undesired by the demand for the design of the appearance of the watch that the portion, as protrudes to the outer side of the case body, of the winding stem takes a position displaced from the thickness center position of the case body.

Under these situations, there has been proposed the winding stem structure (e.g., Swiss Patent No. 691,632 (FIG. 1 and Related Description) or US Patent Laid-Open No. 2001/0046186), which is provided with the first winding stem positioned in the case body, the second winding stem protruding to the outer side of the case body, and the joint portion jointing the first and second winding stems.

In the winding stem structure disclosed in Swiss Patent No. 691,632, however, the stem portions of the first and second winding stems are arranged in one recess of the joint part. In order to position the outer side end portion of the first winding stem, therefore, the outer side end portion has to be borne in a guide hole (or a bearing hole) formed in the inner face of the case band (or the case body). When the movement is assembled in a predetermined position in the case band, therefore, it is not easy to insert the outer side end portion of the first winding stem assembled in advance in the movement, into the guide hole. In order to remove the second winding stem, it is necessary to remove the movement and accordingly to remove the outer side end portion of the first winding stem from the guide hole of the case band. These necessities make the removal/disassembly uneasy. In the winding stem structure disclosed in US Patent Laid-Open No. 2001/0046186, on the other hand, the three gears of the gears of the first and second winding stems and the intermediate gear are clamped between the assembly making plates so that they are integrated. It is, therefore, practically impossible to remove the second winding stem, and it is necessary for the assembly to make the complicated assembling procedure of parts.

The present invention has been conceived in view of the points thus far described and has an object to provided a winding stem structure, which can remove and disassemble two inner and outer winding stem portions, if any, and a watch provided with the winding stem structure.

### SUMMARY OF THE INVENTION

In order to achieve the above-specified object, according to the invention, there is provided a winding stem structure comprising: a first winding stem including a first gear and a first radially small portion; a second winding stem including a second gear for meshing with the first gear and a second radially small portion and juxtaposed through a spacing to the first winding stem; and a joint ring for jointing the first and second winding stems, wherein the joint ring includes: a plate-shaped lever member having a first recess opened at its one end for accepting the first radially small portion of the first winding stem removably, and a second recess opened at its one side for accepting the second radially small portion of the second winding stem; and a return spring removably mounted on the plate-shaped lever member while covering the openings of the first and second recesses of the plate-shaped lever member in the state where the first and second recesses of the plate-shaped lever member accept the first and second winding stems.

In the winding stem structure of the invention, the joint ring includes: a plate-shaped lever member having a first recess opened at its one end for accepting the first radially small portion of the first winding stem removably, and a second recess opened at its one side for accepting the second radially small portion of the second winding stem; and a return spring removably mounted on the plate-shaped lever member while covering the openings of the first and second recesses of the plate-shaped lever member in the state where the first and second recesses of the plate-shaped lever member accept the first and second winding stems. Therefore, the radially small portions of the first and second winding stems can be held at the predetermined positions by the plate-shaped lever member, which is loaded with the spring force of the return spring itself. Therefore, the associated end portions of the first and second winding stems can be held at the predetermined positions by the joint ring itself, which is composed of the plate-shaped lever member and the return spring. Therefore, the corresponding outer side end portion of the first winding stem need not be engaged/retained by the case body (or the case band) or the like. In the winding stem structure of the invention, moreover, the return spring is so removably and elastically mounted on the plate-shaped lever member as to cover the first and second recesses of the plate-shaped lever member. Merely by removing the return spring partially from the plate-shaped lever member against its own elastic force, the plate-shaped lever member can be removed for the disassembly from the second winding stem. Therefore, the second winding stem can be removed from the second recess of the plate-shaped lever member. By extracting the first winding stem together with the movement to the outside of the case body (or the case band) after the second winding stem was extracted, therefore, the return spring and the plate-shaped lever member can be easily extracted so that the first winding stem can also be exposed and extracted.

Here, the first and second radially small portions to be fitted in the first and second recesses of the plate-shaped lever may be the end faces or the like of gears radially larger than the radially small portions, although they have the radially large stem portions on the two sides, so long as the axial movement of the second winding stem can be transmitted through the plate-shaped lever member to the first winding stem.

Typically in the winding stem structure of the invention, the return spring is made of a U-shaped leaf spring. Therefore, this leaf spring can regulate the position of the plate-shaped lever member in three directions. Upon the assembly, merely by arranging the return spring at a predetermined position around the plate-shaped lever member, for example, the plate-shaped lever member can be arranged by the spring force of the return spring itself at the predetermined position to accept the first and second winding stems in the first and second recesses. Upon the disassembly/extraction, the lever member is enabled to open the second winding stem merely by opening the U-shaped return spring leg portions against the spring force.

Here in the winding stem structure of the invention, the leading end portions of the “U” two leg portions of the leaf spring are typically bent inward to prevent the plate-shaped lever member from coming out. Therefore, the leaf spring can regulate the position of the plate-shaped lever member in all the four directions. Merely by retaining the leading end portions of the “U” two leg portions of the leaf spring as the return spring on the plate-shaped lever member or by releasing these retentions, therefore, the leaf spring portion as the return spring can be mounted on and released from the plate-shaped lever member.

In this case, there is typically formed in the “U” bottom portion of the leaf spring the notch or opening for permitting a portion of the first gear to protrude therethrough. In this case, the return spring is positioned by lightly pushing the bottom portion of the “U” onto the first gear.

In the winding stem structure of the invention, the return spring is typically expanded in the longitudinal direction of the first and second winding stems so that the lever member may be so held together with the first and second winding stems as to move in the extending direction of those winding stems. With the return spring being supported with respect to the stationary member such as the main plate, therefore, the first and second winding stems can be pulled out and pushed into together with the lever member with respect to the return spring so that they can function like the ordinary single winding step when the position of the time indicating hand or the calendar wheel is to be adjusted.

In the winding stem structure of the invention, that portion of the second winding stem, which is located on the leading end side of the second gear, is typically tapered and converged. In this case, the first recess of the plate-shaped lever member is fitted on the radially small portion of the first winding stem integrated with the movement (or the body), and the return spring is fitted on the plate-shaped lever member. In this state, the movement is arranged at the predetermined position in the case band. The second winding stem is inserted from the winding stem inserting hole of the wall portion of the case band, and the leading end converging portion of the second winding stem is inserted into the second recess of the plate-shaped lever member. As a result, the second winding stem can be mounted at the predetermined position of the second recess of the plate-shaped lever member, which is loaded by the return spring, such that the plate-shaped lever member is displaced. Thus, it is possible to facilitate the assembly of the winding stem structure.

### BRIEF DESCRIPTION OF THE SEVERAL VIEWS OF THE DRAWINGS

A preferred form of the present invention is illustrated in the accompanying drawings in which:

FIG. 1 is an explanatory section showing a portion of a wrist watch, which is provided with a winding stem structure according to one preferred embodiment of the invention (although a transmission lever return spring is shown by phantom lines);

FIG. 2 is explanatory views showing the winding stem structure of the wrist watch of FIG. 1, and 2A presents a section taken along line II-II of FIG. 1, and 2B a similar section of a joint ring of 2A;

FIG. 3 is an explanatory plan view (omitting the crown) showing the states of the winding stem structure when the winding stem structure is pushed in the wrist watch of FIG. 1 and the peripheral related parts and taken along line III-III of FIG. 1; and

FIG. 4 is an explanatory plan view similar to FIG. 3 but showing the states of the winding stem structure when the winding stem structure is extracted in the wrist watch of FIG. 1 and the peripheral related parts.

### DETAILED DESCRIPTION OF THE PREFERRED EMBODIMENTS

One preferred embodiment of the invention will be described in connection with one preferred embodiment with reference to the accompanying drawings.

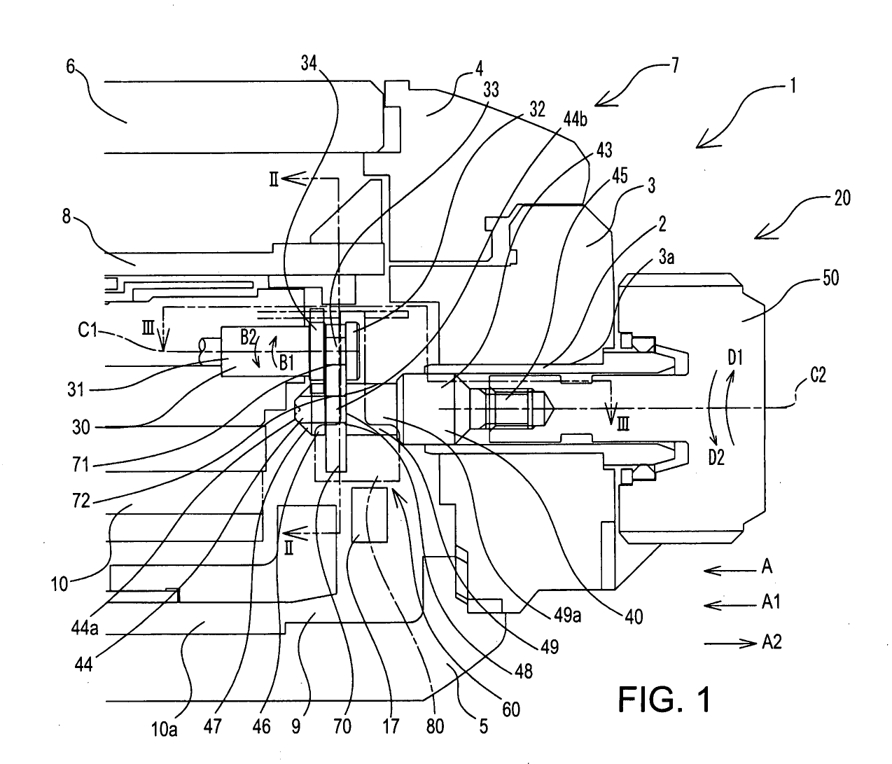

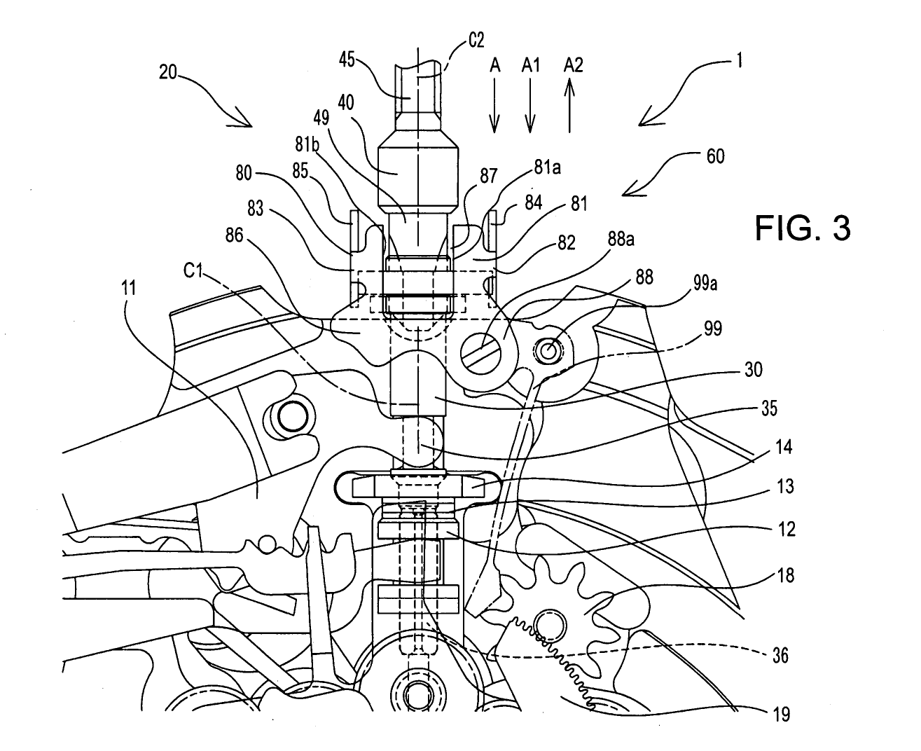

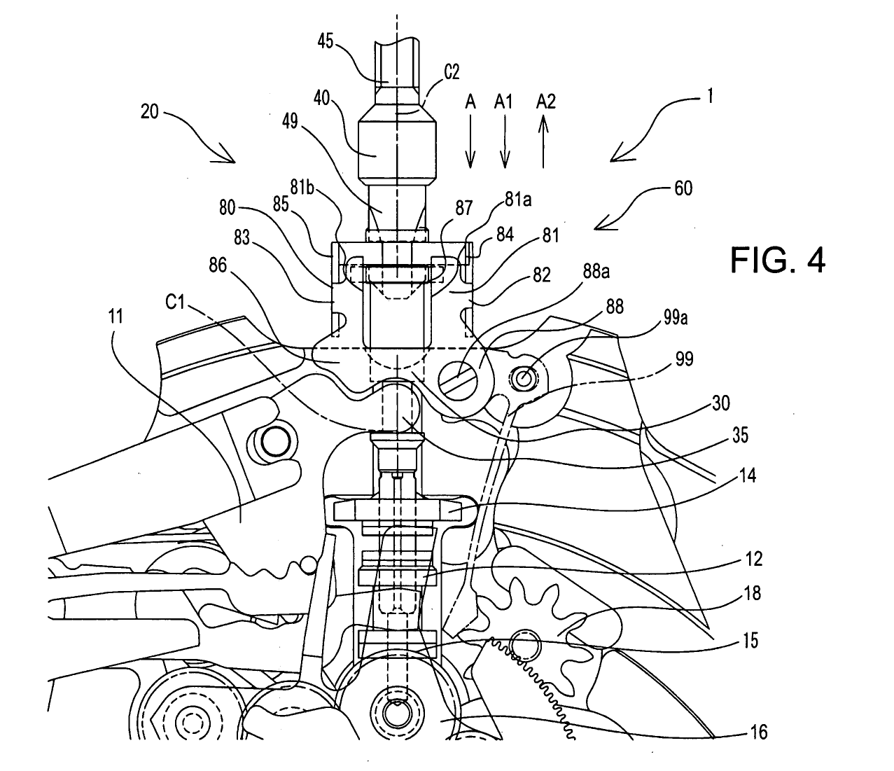

In FIG. 1, FIG. 3 and FIG. 4, there is shown a portion of a wrist watch 1, which is provided with a winding stem structure 20 of one preferred embodiment according to the invention.

The wrist watch 1 is provided with: a case 7, which is composed of a case band 3 forming a case body and fitting a guide tube 2 in a through hole 3a, a bezel 4 mounted on the front face side of the case band 3, a case back 5 mounted on the back side of the case band 3, and a case 7 having a glass 6 fitted in the bezel 4; and a movement 10 in a space 9 between a dial 8 in the case 7 and the case back 5.

The winding stem structure 20 is provided with: a first winding stem 30 arranged in the space 9; a second winding stem 40 engaging at its inner side end portion with the first winding stem 30 and fitted at its outer side end portion in the through hole 3a; a crown 50 fixed on the outer side end portion of the second winding stem 40; and a joint ring 60 for holding the first and second winding stems 30 and 40 singly in a jointed state.

The first winding stem 30 can turn on a center axis C1 in directions B1 and B2 and can move along the extending direction A of the axis C1 in directions A1 and A2. The first winding stem 30 is provided with: a cylindrical stem portion 31 forming the body of the first winding stem 30; a radially small stem portion 33 formed as a first radially small portion near the root end portion 32 of the stem portion 31; and a first gear 34 fixed on the stem portion 31. The first winding stem 30 includes, at its deep side portion, a radially small portion 35, with which one end of a setting lever 11 engages, and a non-cylinder stem portion 36, on which a clutch wheel 12 is fitted. If the wrist watch 1 is of a mechanical type, the clutch wheel 12 meshes at its O-teeth 13 with a winding pinion 14, in case the first winding stem 30 is at an ordinary position or at a reference position, so that it can wind the mainspring according to the turns of the first winding stem 30. In case the first winding stem 30 is at the extracted position, the clutch wheel 12 meshes at its K-teeth 15 with a setting wheel 16, so that it can adjust the turning position of a calendar wheel or the turning position of the time indicating hand in accordance with the turns of the first winding stem 30 depending on the degree of the extraction.

The second winding stem 40 can turn on the center axis C1 in directions D1 and D2 and can move along the extending direction A of the axis C1 in the directions A1 and A2. The second winding stem 40 is provided with: a radially large stem portion 43 and a radially small leading end portion 44, which are fitted slidably in the extracting and pushing directions A1 and A2 along the guide tube 2 extending at the center of the height direction of the case band 3 in the radial direction of the watch 1; and a root end side radially small portion 45, on which the crown 50 is fixed. The second winding stem 40 is further provided, at an intermediate portion of the leading end radially small portion 44, with a second gear 46 to mesh with the first gear 34 of the first winding stem 30, at the radially small leading end portion of the radially small leading end portion 44 farther leading than the second gear 46, with a frusto-conical guide portion 47, and, at the leading end of the radially small portion 44, with a tapered portion 44a, which is converged to facilitate insertion at the assembling time. This guide portion 47 has its maximum diameter equal to or slightly larger than the external diameter of the second gear 46. At the portion of the second winding stem 40 between the radially small leading end portion 44 and the radially large stem portion 43, there is formed through a step portion 48 a tapered joint portion 49, the cylindrical stem portion 49a of which has an external diameter substantially equal to the external diameter of the gear 46 or the maximum diameter of the guide portion 47.

The joint ring 60 includes a transmission lever 70 acting as a plate-shaped lever member, and a transmission lever return spring 80 acting as a return spring in the mode of a plate-shaped spring member.

The transmission lever 70 has a generally rectangular contour and is provided with: a first recess 71 opened at one end 70a of the rectangle for receiving the first winding stem 30 removably; and a second recess 72 opened at one side 70b for receiving the second winding stem 40 removably. More specifically, the transmission lever 70 includes: first and second side wall forming portions 73 and 74 for defining the first recess 71; an intermediate wall portion 75 for defining the bottom wall of the first recess 71 and one side wall of the second recess 72; a wall portion 76 for defining the bottom wall of the second recess 72; and a third side wall forming portion 77 for defining the other side wall of the second recess. The first side wall forming portion 73 and the wall portion 76 merge into each other to define the other side 70c of the rectangle, the third side wall portion 77 defines the other end 70d of the rectangle. An engaging oblique protrusion 78 is formed at the corner, where the side portion 70c and the end portion 70d merge. Moreover, a retaining slope 77a is formed at the outer side portion of a protrusion 79 at leading end of the third side wall portion 77, and a relief slope 73a is formed at the outer side portion of the leading end of the first side wall forming portion 73.

In the first recess 71, an opening portion 71a and a deep portion 71b have substantially equal widths. In this embodiment, the recess 71 is defined, as viewed in a plan view, by parallel straight side faces 71c and 71d and a semicircular bottom face 71e. The spacing between the side faces 71c and 71d or the semicircular diameter of the bottom face 71e are made such that the radially small stem portion 33 of the first winding stem 30 may be just fitted on the bottom face 71e of the recess 71. On the other hand, the second recess 72 has a larger width at its opening portion 72a than that of a deep portion 72b. In this embodiment, the recess 72 is composed, as viewed in a plan view, of a generally semicircular bottom face 72c for fitting the leading end side radially small portion 44 of the second winding stem 40 snugly, and arcuate portions 72d and 72e having a larger diameter than that of the bottom face 72c.

Specifically, the transmission lever 70 is so shaped when the gear 34 of the first winding stem 30 and the gear 47 of the second winding stem 40 that the radially small stem portion 33 of the first winding stem 30 is fitted in the semicircular bottom face portion 71e of the recess 71 and that the leading end side radially small portion 44 of the second winding stem 40 is snugly fitted in the semicircular bottom face portion 72c of the recess 72. When the winding stems 30 and 40 are fitted in the recesses 71 and 72 of the transmission lever 70, this transmission lever 70 has such a thickness that it is snugly fitted between the first gear 34 and the root end side stem portion 32 of the first winding stem 30 and between the second gear 47 and the step portion 48 of the second winding stem 40.

When the first and second recesses 71 and 72 of the transmission lever 70 accept the first and second winding stems 30 and 40, the transmission lever return spring 80 is so removably mounted on the transmission lever 70 as to cover the openings 71a and 72a of the recesses 71 and 72 of one end 70a and one side 70b of the transmission lever 70.

More specifically, the transmission lever return spring 80 is formed to have a generally U-shaped side face shape by punching and bending a sheet metal, and is composed of a bottom portion 81 of the “U” shape and two leg portions 84 and 85 of the “U”, which merge at bent portions 82 and 83 into the individual end portions of the bottom portion 81.

The bottom portion 81 is provided with a protrusion 86, which is positioned to confront the first recess 71 of the transmission lever 70 and to come close to the setting lever 11, as shown in FIG. 3 and FIG. 4. The bottom portion 81 is provided with: a notch 87 fitting the gear 34 so loosely at its central portion as to permit the movement of the gear 34 in the directions A1 and A2; and a screwing protrusion 88 for fixing one side of the protrusion 86 removably on the main plate. In this embodiment, the two side edges 81a and 81b of the bottom portion 81 are so narrowed at the central portion in the direction A as to form spring portions 89 and 90 in cooperation with the leg portions 84 and 85.

The leg portion 84 is provided with a root end side leg portion 91 narrowed in the direction A and a wide leading end side leg portion 92. This leading end side leg portion 92 is so folded at its leading end portion 93 inward with respect to a leading end side leg body portion 94 that it may engage at its mounted position with the transmission lever 70.

The leg portion 85 has a mirror-symmetric shape with the leg portion 84, and is provided with a root end side leg portion 95 narrowed in the direction A and a wide leading end side leg portion 96. This leading end side leg portion 96 is so folded at its leading end portion 97 inward with respect to a leading end side leg body portion 98 that it may engage at its mounted position with the transmission lever 70.

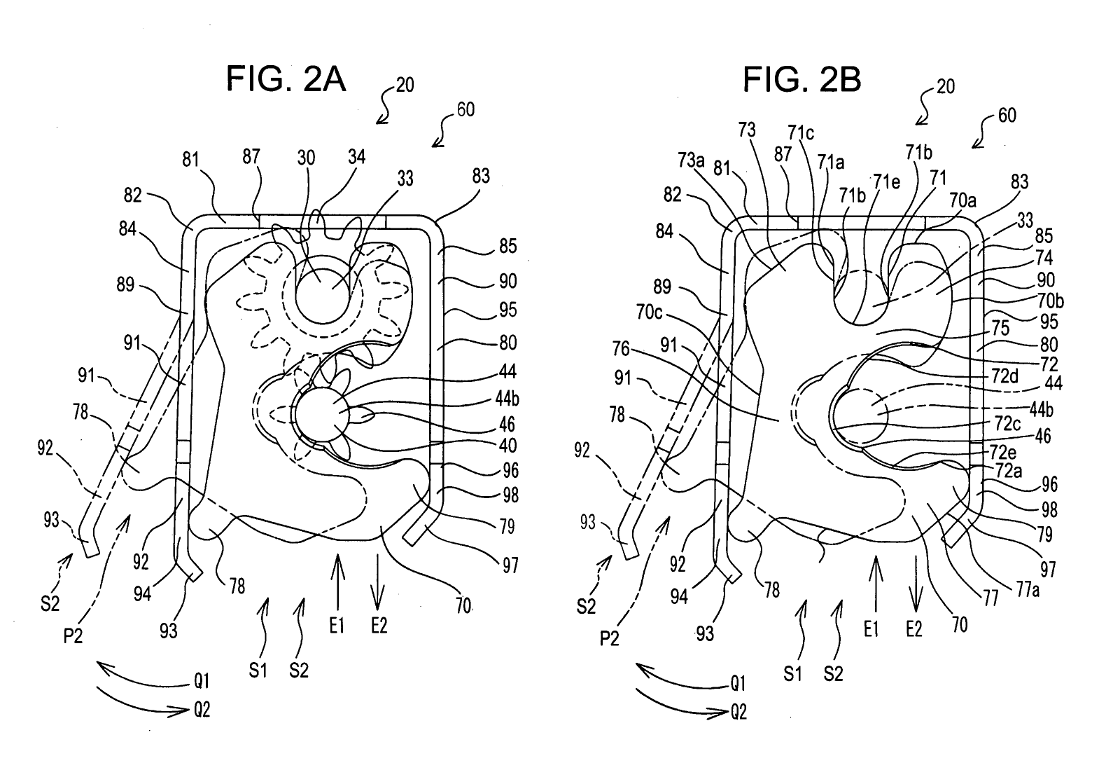

In a state S1 where the joint ring 60 is mounted, the radially small stem portion 33 of the first winding stem 30 is fitted to the bottom face 71e of the first recess 71, and the radially small stem portion 44 of the second winding stem 40 is fitted to the bottom face 72c of the second recess 72, as shown by solid lines in FIGS. 2A and 2B. As a result, the transmission lever return spring 80 is elastically pushed toward the lever member 70 positioned with respect to the first and second winding stems 30 and 40 at the leading end side leg portion body portions 94 and 98 of the two leg portions 84 and 85 against the protrusions 78 and 79 of the lever member 70. Therefore, the spring 80 regulates the mounted position P1 of the transmission lever 70 with respect to the first and second winding stems 30 and 40 such that the leading end portions 94 and 98 of the leg portions 84 and 85 are slightly deflected outward. In this mounted state S1, the first gear 34 of the first winding stem 30 is so protruded from the notch 87 formed in the bottom portion 81 of the transmission lever return spring 80 that its portion is loosely fitted in the notch 87.

If, in this mounted state S1, the return spring 80 is displaced in a direction E1 with respect to the transmission lever 70 or the winding stems 30 and 40 so that the lever 70 comes in a direction E2 out of the leg portions 84 and 85 of the spring 80, the protrusions 78 and 79 of the transmission lever 70 are regulated by the retaining end portions 93 and 97 of the spring 80 so that the spring 80 hardly comes out of the lever 70. In other words, so long as the plays in the directions E1 and E2 are small, the positions of the transmission lever 70 in the directions E1 and E2 with respect to the return spring 80 need not be strictly regulated. In order to retain the engagement between the gears 34 and 46, however, the return spring 80 is typically lightly pushed in the direction E2 so that it is positioned in abutment against the gear 34.

In the mounted state S1 where the transmission lever 70 is at the close position P1, its displacement in the leaving direction, as indicated by arrow Q1 at in FIGS. 2A and 2B, is regulated by the spring force of the spring 80. In the mounted state S1 where the transmission lever 70 is thus positioned at the mounted position P1, what exists between the recesses 71 and 72 of the transmission lever 70 and the stem portions 33 and 44 is some friction in the extending direction A of the first and second winding stems 30 and 40. Therefore, the first and second winding stems 30 and 40 can move in the directions A1 and A2 with respect to the joint ring 60.

When the leading end portion 92 of the leg portion 84 of the transmission lever return spring 80 is opened in the direction Q1 from the mounted position P1, as indicated by the solid lines in FIGS. 2A and 2B, the transmission lever 70 is released from the regulation in a direction Q2 so that it can move in the direction Q2. When the spring 80 and the transmission lever 70 move in the direction Q2 and reach a released position P2, as indicated by phantom lines, the gear 46 comes into the ranges of the radially large arcuate portions 72d and 72e of the second recess 72 so that the second winding stem 40 can be extracted.

In FIG. 1, an independently extractable casing ring 17 is arranged in the space 9 in the inner side of the case back 5. In this space 9, there is also positioned of an automatic winding sector-shaped oscillating weight 10a, which forms part of the movement 10. However, the casing ring 17 maybe dispensed with, and the oscillating weight 10a may take a different position and may also be dispensed with.

With reference to the drawings, here will be described more specifically the operations to mount and demount the winding stem structure 20 in the wrist watch 1, which is provided with the winding stem structure 20 having the joint ring 60 thus constructed.

First of all, the first winding stem 30 is assembled at a predetermined position with respect to the movement 10. Next, the first recess 71 of the transmission lever 70 is fitted on the radially small stem portion 33 of the first winding stem 30. Then, the transmission lever return spring 80 is mounted on the assembly of the first winding stem 30 and the transmission lever 70 and is fixed on the main plate at the screwing protrusion 88 by a screw 88a. At the time of mounting the transmission lever return spring 80, the return spring 80 is pushed in the direction E2 with respect to the first winding stem 30 and the transmission lever 70 till the gear 34 of the first winding stem 30 comes into light abutment against the edge portion of the notch 87 of the return spring 80. In the state where the joint ring 60 composed of the transmission lever 70 and the transmission lever return spring 80 is thus mounted at a predetermined position with respect to the first winding stem 30, the movement 10 is fitted together with the joint ring 60 in a predetermined position in the case band 3. Here, the state where the joint ring 60 is attached to the first winding stem 30 corresponds to the state, which is indicated by the solid lines in FIG. 2A , or the state lacking the second winding stem 40 in FIG. 1.

Next, the second winding stem 40 is inserted into the guide tube 2 extending along its center axis, and further into the recess 72 of the transmission lever 70 positioned along a center axis C. At this time, the second winding stem 40 is provided at its leading end with the leading end portion 44a, which is tapered to have a slightly smaller diameter at its leading end than that of the radially small stem portion. Further provided is the frusto-conical portion 47 which is tapered to the largest size portion having a diameter equal to that of the second gear 46. Therefore, the second winding stem 40 is fitted in the predetermined position while the bottom face 72c of the second recess 72 being slightly displaced in the direction Q1 against the spring force of the spring 80, so that the second winding stem 40 is fitted in the recess 72 at the portion (or the second radially small portion) 44b of the radially small portion 44 between the second gear 46 and the step face 48. As a result, the second winding stem 40 is returned in the direction Q2 of the transmission lever 70 to the predetermined position, as indicated by the solid lines in FIG. 2A. Thus, the assembly of the winding stem structure 20 is completed.

In this wrist watch 1, as has been described hereinbefore, the first and second winding stems 30 and 40 constructing the winding stem structure 20 are jointed by the joint ring 60, which is composed of the transmission lever 70 and the transmission lever return spring 80, so that the construction/assembly of the winding stem structure 20 can be performed easily and reliably. Thus, the assembly can be facilitated because the joint ring 60 supports the winding stems 30 and 40 while being fixed only in the movement 10 but not in the casing such as the case band 3, and because the joint ring 60 itself has an easily assembled structure.

At the time of assembling the watch 1, the casing ring 17 and so on are then mounted, and the case back 5 is closed.

In the wrist watch 1 having the winding stem structure 20 thus assembled, the first and second winding stems 30 and 40 are fitted at their radially small stem portions 34 and 44b in the recesses 71 and 72 of the transmission lever 70, and this transmission lever 70 is supported by the return spring 80 which is fixed on the main plate by the screw 88a. As the second winding stem 40 is turned in the directions D1 and D2 on its center axis C2, therefore, the first winding stem 30 meshing through the first gear 34 with the second gear 46 of the second winding stem 40 can be turned on the center axis C1 in the directions C2 and C1.

In this winding stem structure 20 of this wrist watch 1, moreover, the transmission lever 70 is fitted on the radially small stem portion 33 between the gear 34 and the stem portion 34 of the first winding stem 30 and on the radially small portion 44b between the gear 46 and the step portion 48 of the second winding stem 40. As the second winding stem 40 is moved along its center axis C2 in the direction A, therefore, the first winding stem 30 is also moved through the transmission lever 70 along its center axis C1 in the direction A. In the winding stem structure 20 of this wrist watch 1, moreover, the transmission lever 70 is supported at its protrusions 78 and 79 in the direction A of the return spring 80 by the wide leg portions 92 and 96, and the notch 87 for permitting the movement of the gear 34 in the direction A is formed in the bottom portion 81 of the return spring 80. Therefore, the movement of the transmission lever 70 in the direction A can be guided by the return spring 80. In this wrist watch 1, therefore, when the second winding stem 40 fixing the crown 50 of the winding stem structure 20 is extracted along its center axis C2 in the direction A2 by pulling the crown 50 in the direction A2, the transmission lever 70 engaged by the second winding stem 40 is also moved in the direction A2 so that the first winding stem 30 is also moved along its center axis C1 in the direction A2 in accordance with the movement of the transmission lever 70 in the direction A.

In accordance with the extracted positions of the second and first winding stems 40 and 30, therefore, the clutch wheel 12 is positioned at the predetermined position through the rocking motion of the setting lever 11 and the like, so that the calendar and the time can be corrected according to the turn of the second winding stem 40 in the direction D1 or D2.

On the other hand, the description thus far made can be applied to the operation of the case, in which the crown 50 is pushed in the direction A1, excepting that it is just reversed from that of the extracting operation.

In case the winding stem structure 20 of this wrist watch 1 is to be disassembled or removed, the case back 5 is opened to remove the casing ring 17. After this, the oscillating weight 10a is turned, if necessary, to expose the joint ring 60 to the outside. With respect to the joint ring 60 in the solid-line state in FIG. 2A, the leading end portion 92 of the leg portion 84 or its engaging end portion 93 of the leg portion 84 is opened in the direction Q1 by forceps against the spring force of the narrow spring portion 91 in the direction Q1, and the transmission lever 70 is moved in the direction Q1. When the transmission lever 70 reach the position indicated by the phantom lines in FIG. 2A by the movement in the direction Q1, the gear 46 can be extracted through the second recess 72 in the direction A2. Therefore, the crown 50 is pulled in the direction A2 to pull out the second winding stem 40 from the transmission lever 70 in the direction A2 and is extracted from the guide tube 2. After this, the joint ring 60 may be extracted to the outside of the space 9 of the case band 3 together with the first winding stem 30 attached to the movement 10. Then, the screw 88a may be removed to separate the return spring 80, and the transmission lever 70 may be removed.

In this wrist watch 1, as has been described hereinbefore, the first and second winding stems 30 and 40 constructing the winding stem structure 20 are jointed by the joint ring 60 composed of the transmission lever 70 and the transmission lever return spring 80, so that the winding stem structure 20 can be disassembled and extracted easily reliably. Thus, the disassembly/extraction can be facilitated because the joint ring 60 is fixed only on the movement 10 but not on the casing such as the case band 3 thereby to support the winding stems 30 and 40 and because the joint ring 60 itself has an easily disassembled structure.

The return spring 80 has been described hereinbefore, as if it were the new member the conventional watch lacks in. However, the return spring 80 may be formed integrally with a jumper 99 for regulating the pawl wheel 18, which meshes at its gear portion 18a with a ratchet wheel 19 connected to the (not-shown) remainder indicating hand for indicating the drivable time period of the (not-shown) mainspring, for example, as indicated by the phantom lines in FIG. 3 and FIG. 4. In this case, the integrated member of the jumper 99 and the transmission lever return spring 80 is fitted on the pin of the main plate through a positioning guide hole 99a and by means of the pin 88a. It is quite natural that the transmission lever return spring 80 may be integrated with a desired member other than the jumper 99.

Moreover, there has been described the embodiment, in which the first and second winding stems 30 and 40 constructing the winding stem structure mesh directly with each other. However, the gear 46 of the second winding stem 40 may mesh with another intermediate gear, which meshes with the gear 34 of the first winding stem 30. In this modification, the transmission lever 70 is provided, between the first recess 71 and the second recess 72 (although the second recess is positioned apart from the first recess), with a third recess, which is opened like the second recess 72 in the side portion 70b, so that it is fitted on the stem of the intermediate gear at the third recess thereby to support the intermediate gear. In this modification, the transmission lever 70 need not be made of a sheet of plate-shaped member but may be a folded plate-shaped member for supporting the two sides of the stem portions of the intermediate gear.

1. A winding stem structure comprising:
a first winding stem including a first gear and a first radially small portion; a second winding stem including a second gear for meshing with the first gear and a second radially small portion and juxtaposed through a spacing to the first winding stem; and a joint ring for jointing the first and second winding stems,
wherein the joint ring includes:
a plate-shaped lever member having a first recess opened at its one end for accepting the first radially small portion of the first winding stem removably, and a second recess opened at its one side for accepting the second radially small portion of the second winding stem; and
a return spring removably mounted on the plate-shaped lever member while covering the openings of the first and second recesses of the plate-shaped lever member in the state where the first and second recesses of the plate-shaped lever member accept the first and second winding stems.

2. A winding stem structure as set forth in claim 1,
wherein the return spring is made of a U-shaped leaf spring.

3. A winding stem structure as set forth in claim 2,
wherein the “U” two leg portions of the leaf spring are bent at their leading end portions inward to prevent the plate-shaped lever member from coming out.

4. A winding stem structure as set forth in claim 1,
wherein the return spring expands in the longitudinal direction of the first and second winding stems so as to hold the lever member together with the first and second winding stems movably in the extending direction of the winding stems.

5. A winding stem structure as set forth in claim 1,
wherein the portion of the second winding stem on the leading end side of the second gear is tapered to converge.

6. A watch comprising a winding stem structure as set forth in claim 1.
